(19) United States
(12) Patent Application Publication
(10) Pub. No.: US 2006/0084344 A1
(43) Pub. Date: Apr. 20, 2006

(54) Nonwoven web material with spunbond layer having absorbency and softness

(75) Inventor: Achai Bonneh, Kokhav (IL)

Correspondence Address: Breiner & Breiner, L.L.C., P.O. Box 19290, Alexandria, VA, 22320-0290, US

(73) Assignee: AVGOL Nonwovens Ltd., Tel Aviv (IL)

(21) Appl. No.: 10/963,627

(22) Filed: Oct. 14, 2004

(51) Int. Cl. B32B 5/26; B32B 5/06; D04H 1/46; D04H 1/54

(52) U.S. Cl. 442/382; 442/409; 442/341; 442/408; 442/389; 442/387

(57) ABSTRACT

A nonwoven web material made up of a composite of at least two layers is described. The at least two layers include a spunbond continuous fiber layer and a meltblown fiber layer. The composite is subjected to thermal calender bonding and water jet treatment. The water jet treatment serves to break meltblown fibers and cause ends thereof to extend through the spunbond layer. The ends sticking out provide a velvet-like surface to the exterior of the web material and, thus, softness to the web material. The water jet treatment does not destroy the thermal calender bonds. The web material has a mean flow pore size of between about 10 and about 100 microns. The mean flow pore size defines primary absorbent characteristics in the web material, e.g., absorptive capacity, absorption rate and wicking ability.

### FIELD OF INVENTION

The invention is directed to a nonwoven web material, and a process for making the web material, composed of at least two layers, a spunbond fiber layer and a meltblown fiber layer. The layers are subjected to thermal calender bonding and water jet treatment. The water jet treatment is under conditions sufficient to break at least a portion of the meltblown fibers and push broken edges of the fibers through to an opposite side so as to extend through the exterior surface of the material. The calender bonds remain intact. The nonwoven web material has a mean flow pore size which defines the primary absorbent characteristics provided in the web material, in particular, absorptive capacity, absorptive rate and wicking ability.

### OBJECTS AND SUMMARY OF THE INVENTION

An object of the invention is a nonwoven web material having softness while including a meltblown fiber layer.

A further object of the invention is a nonwoven web material provided with absorbency in the absence of an additive in or on the web material based on the web material having a particular mean flow pore size which defines the primary absorbent characteristics of the web material.

A further object of the invention is a nonwoven web material with enhanced properties through the integration of different processing features into alternatively one continuous process or predetermined stages.

A further object is a nonwoven web material having primary absorbent characteristics, such as absorptive capacity, absorptive rate and wicking, based on the structure of the web material and which has secondary absorptive characteristics, such as an increased absorbency rate, based on additive treatment of the formed web material, either topically or internally.

The invention is directed to a nonwoven web material and a process of making the web material. The web material is a composite of at least two layers, a spunbond (S) continuous fiber layer and a meltblown (M) fiber layer. The composite can be varied as to the layer makeup depending on the use to which the web material is to be applied. For example, the composite can be SM, SMS, SSMMS, SSMMMS, MSM or the like.

The at least one spunbond layer of the nonwoven material is made of continuous fibers, preferably of thermoplastic polymer(s), such as polyolefins, and are made in a conventional manner. Accordingly, due to the spunbond nature of the fibers, such are generally provided by extrusion onto a moving conveyor belt and thereafter subjected to thermal calendering or thermodeformation. Thus, the layer of spunbond fibers loses softness. The spunbond fibers in the nonwoven material of the invention have a denier of about 1 to about 3 denier per fiber (dpf).

The at least one layer of meltblown fibers is formed by a conventional means, e.g., an extruder. The meltblown fibers are laid on a moving conveyor belt to form a layer. The meltblown fibers are formed within certain parameters to provide a lofty meltblown layer having a mean fiber diameter of less than 10 microns, preferably in a range of about 3-about 8 microns depending upon the working conditions. The meltblown layer is preferably laid on the spunbond layer to provide a composite.

The composite is subjected to thermal calendering resulting in fiber to fiber bonding followed by treatment with at least one water jet, preferably on both sides of the composite, under conditions so that at least a portion of the meltblown fibers are broken by the water jet or jets with the ends of the meltblown fibers remaining long enough so that at least a portion of the ends push through the spunbond layer and extend out of the spunbond layer to thereby form a soft velvet-like surface externally of the spunbond layer. A portion of the ends of the meltblown fibers may extend into but not out of the spunbond layer with the same soft velvet-like surface still being obtained. The initial fiber to fiber bonding provided by calendering is not destroyed by the action of the water jets. The meltblown fibers can stick out of one or both sides of the composite. The concentration of fibers sticking out is determined by the hydraulic pressure and the number of water jets as well as the meltblown/spunbond fiber ratio. The number of water jets present are preferably from 1 to 10 heads and the pressure of the water in the jets is determined by the quality of the resultant fabric desired, i.e., in a range of about 50 to about 400 bar per head.

The web material of the invention preferably has a mean flow pore size in a range of about 10 to about 100 microns. The mean flow pore size defines the primary absorbent characteristics, such as absorptive capacity, absorptive rate and wicking. The provision of the web material with the inventive mean flow pore size provides or results in an increase in the web material's primary absorbent characteristics. Conventional web material is made using polyolefins which result in a web material which is hydrophobic in nature due to the water repellent nature of the polyolefin material. Thus, conventional nonwoven materials are generally useful as a barrier material to prevent liquids from freely passing through the nonwoven material. If the nonwoven material is to be provided with absorbent characteristics, such material conventionally must be further treated subsequent to manufacture of the nonwoven material or the resin used to make the nonwoven material must be internally modified prior to or during the manufacturing process. The present invention provides absorbency characteristics to a nonwoven material by modification of the structure of the nonwoven material as a result of the mean flow pore size present therein as further described below. Secondary absorbent characteristics can be further controlled or modified by topical treatments of the web material as also further described below.

Following the water jet treatment of the web material, and preferably before drying of the web, the web may be further treated with one or more surfactants topically to further affect by enhancing or modifying web properties such as softness, fluid philicity, fluid phobicity, absorbency and the like. An example of such topical treatment is described in U.S. Pat. Nos. 5,709,747 and 5,885,656, which are incorporated herein by reference.

An alternative to effecting secondary absorbent characteristics following formation of the web material is by including appropriate additives in the polymer melt used to make the meltblown or spunbond fibers. The additives are chosen to modify properties of the fibers, such as to render the fibers hydrophobic, hydrophilic, enhance absorbency, render anti-static or flame retardant, and the like.

A variation upon the topical treatment of the web material is that the surfactants can be applied as an array or in discrete strips across the width of the web material in order to create zone treatments to which different properties can be provided.

The web material of the invention is useful in the making of hygiene products, wipes and medical products.

The invention allows for the production of a nonwoven web material in one continuous process including various features to provide new or enhanced properties within the web material, in particular with respect to absorbency and softness. However, the invention also allows for the production of the nonwoven web material in different individual process stages, e.g., as a two step process wherein one is the manufacture of the spunbond/meltblown composite followed by a second stage involving hydraulic processing of the composite. This versatility allows for cost savings since a continuous line does not have to be provided in one place or utilized in one continual time. Different apparatus can be utilized in different locations and/or according to different scheduling requirements in order to provide for the most expedient use of equipment.

### BRIEF DESCRIPTION OF DRAWING

FIG. 1 is a schematic illustration of an example of a nonwoven web material according to the invention including two spunbond fiber layers and one meltblown fiber layer, following calendering. The schematic shows meltblown fiber ends extending out of each side of the material as well as bonding points provided upon calendering.

FIG. 2 is a micrograph showing an example of the nonwoven material of the invention with bond sites intact.

### DETAILED DESCRIPTION OF THE INVENTION

The nonwoven web material of the invention is a composite of at least two layers, in particular at least one spunbond (S) continuous fiber layer and at least one meltblown (M) fiber layer. The composite can include two or more layers in various combinations, such as SM, SMS, SSMMS, SSMMMS, MSM and the like. The web material preferably has a basis weight in a range of about 8 to about 60 grams per square meter (gsm). The fibers of each layer are made of a thermoplastic polymer, preferably polyolefins, and more preferably polypropylene or polyethylene. Other polymers suitable for use include polyesters, such as polyethylene terephthalate; polyamides; polyacrylates; polystyrenes; thermoplastic elastomers; and blends of these and other known fiber forming thermoplastic materials.

The spunbond fibers have a basis weight of preferably at least about 3 gsm and a denier of about 1-3 dpf. The meltblown fibers preferably make up at least 2% of the total composite weight of the web material and can have a denier within a varying range depending upon the application of the web material. Preferably, the meltblown fibers have a diameter of about 3-8 microns. The fibers can be a mixture of monocomponents or bicomponent materials.

In the preparation of the web material, the layers are formed by conventional means, i.e., the fibers are produced by extruders with the fibers being laid upon a moving mesh screen conveyor belt to form multiple layers in stacked relationship with each other. More specifically, a moving support (which can be a belt, mesh screen, or the like) moving continuously along rollers is provided beneath the exit orifices for one or more extruders. An extruder receives a polymeric melt which is extruded through a substantially linear diehead to form a plurality of continuous filaments which are randomly drawn to the moving support to form a layer of fibers thereon. The diehead includes a spaced array of die orifices having diameters of generally about 0.1 to about 1.0 millimeters (mm). The continuous filaments following extrusion are quenched, such as by cooling air.

Positioned downstream in relation to the moving support in the processing direction can be additional extruders for providing continuous filaments. These filaments are randomly drawn to the moving support and are laid atop a preceding deposited layer to form superposed layers. Thus, if desired, along one continuous line a multi-layer nonwoven material can be provided.

The multi-layer composite is then calendered and moved for treatment by at least one water jet.

In the invention, the calendering of the fibers subjects the fibers forming the spunbond layer to thermodeformation. The thermodeformation decreases the tactile properties of the spunbond layer. The treatment by at least one high pressure water jet is preferably by at least one water jet on each side of the web material, more preferably, by from 1 to 10 water jets on each side. The water jets serve to break at least a portion of the meltblown fibers so that at least a portion of the ends of the broken fibers extend outward of the spunbond layer(s). Such broken ends sticking out of the spunbond layer(s) serve to provide external softness to the web material due to the provision of a velvet-like surface based on the outward extending ends of the meltblown fibers. The water jet treatment of the web material does not destroy the bonds formed by calendering.

The meltblown fibers capable of being broken apart by water jets in accordance with the invention are produced by an extruder having throughputs in a range of about 0.05-about 1.0 grams per hole per minute (gr/hole/min), and a stretching air speed in a range of about 30-about 150 meters per second (m/s). The resin utilized preferably has a melt flow index (MFI) of approximately 400-3000. The melt temperature of the resin should be in a range of about 240° C.-about 320° C. The distance from the extruder die head to the conveyor belt should be greater than 75 mm. Meltblown fibers produced in this manner and provided as a layer result in a lofty meltblown layer having a mean fiber diameter of less than 10 microns, and preferably about 3-8 microns, depending on the working conditions.

When the multi-layer composite is subjected to water jet treatment, preferably from both sides of the composite, at least a portion of the meltblown fibers are broken by the water jets and the edges remain long enough to push through the spunbond layer or layers and extend out of the spunbond layer or layers to form the soft velvet-like exterior surface. The water jets are preferably present in an amount of 1-10 heads per side and the water is provided at a pressure predetermined by the quality of the resultant fabric desired. Preferably the pressure of the water in the jets is in a range of about 50-about 400 bar per head. The meltblown fibers which stick out one or both sides of the composite have a concentration which is determined by the hydraulic pressure and number of jets as well as the ratio of the meltblown fibers to spunbond fibers present in the layers.

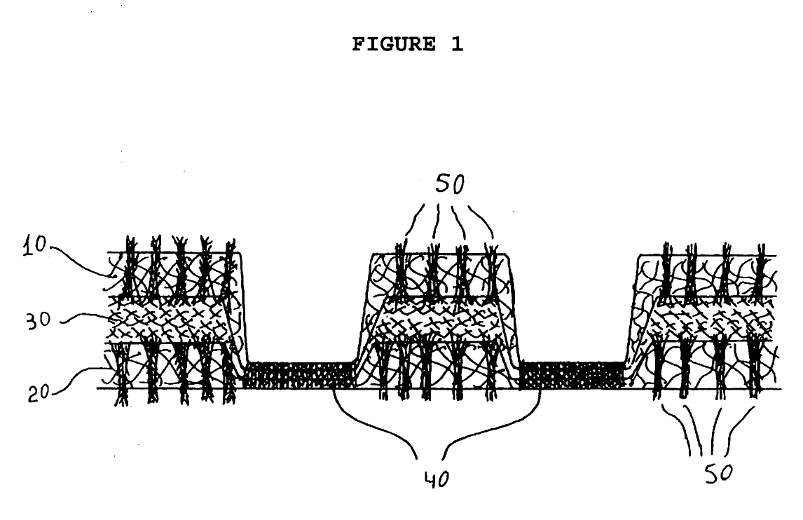

In FIG. 1, an exemplary web material of the invention is illustrated. The layers denoted by 10 and 20 indicate first and second spunbond layers and the layer denoted by 30 indicates a meltblown fiber layer. The fibers denoted by 50 indicate meltblown fibers which have been broken and extend through the spunbond layers to provide a soft outer surface to the web material. The areas denoted by 40 are bonding points created by calendering the layers of web material.

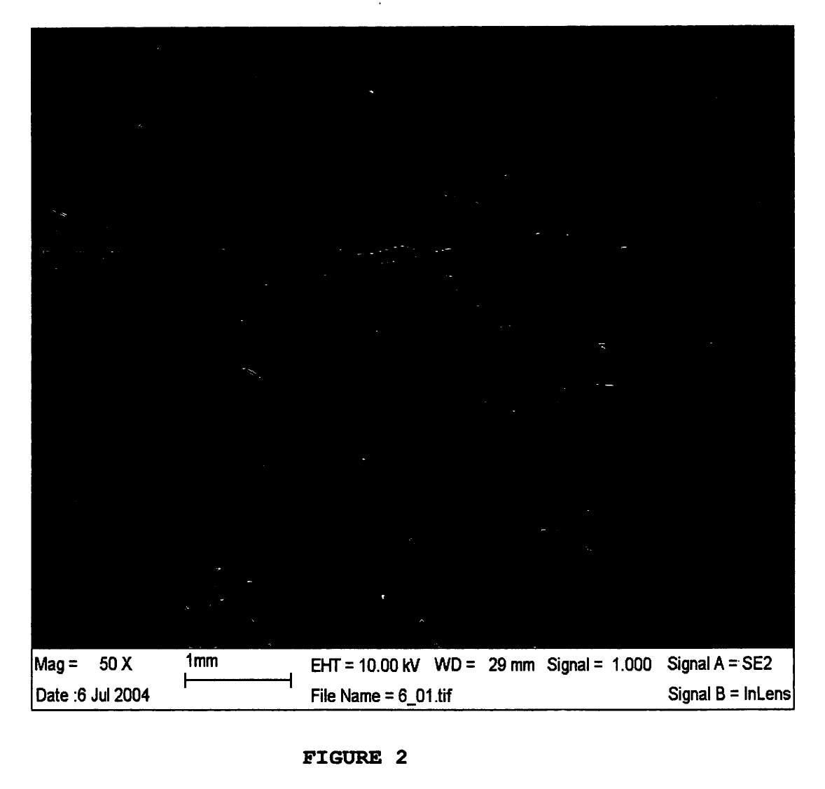

FIG. 2 provides a view of a nonwoven web material according to the invention showing intact bond sides. The magnification is at 50 times.

The web material of the invention is preferably provided with a mean flow pore size in a range of about 10 to about 100 microns. Primary absorbent characteristics, such as absorptive capacity, absorptive rate and wicking, are thus provided to the web material.

The test method for measurement of the mean flow pore size as described above utilizes a PMI Porometer in accordance with the general F316-89 and ASTM E1294-89 methods. The PMI test equipment was prepared to provide a compressed dry air pressure (regulator head) of 5 bar. Calibration included adjusting flow parameters and calculating Lohm and max air flow. CAPWIN Software Version 6.71.08 is used. The sample holders include 0.5 cm diameter sample adapter plates. The PMI CAPWIN test parameters are in the table set forth below:

TABLE
PMI CAPWIN Parameters

| | |
|---|---|
| Parameter | Value |

Bubble Point/Integrity Test

| | | |
|---|---|---|
| Bulbflow | 1.00 | cm3 min−1 |
| F/PT (Old Bulbtime) | 250 | |
| Minbppres | 0.00 | bar |
| Zereotime | 2.0 | sec |

Motorized Valve 2 Control

| | |
|---|---|
| V2incr | 10 |

Regulator Control

| | | |
|---|---|---|
| Preginc | 10 | cts |
| Pulse delay | 0 | sec |

Lohm Calibration

| | | |
|---|---|---|
| Maxpress | 1 | bar |
| Pulsewidth | 0.2000 | sec |

Stability Routine #1

| | | |
|---|---|---|
| Mineqtime | 30 | sec |
| Presslew | 10 | cts |
| Flowslew | 50 | cts |
| Eqiter | 5 | cts |

Stability Routine #2

| | | |
|---|---|---|
| Aveiter 30 | | sec |
| Maxpdif | 0.01 | bar |
| Maxfdif | 50.0 | cm3 min⁻¹ |

Current Test Status Graph Scale

| | | |
|---|---|---|
| Statp | 0.1 | bar |
| Statf | 500 | cm3 min⁻¹ |

Leak Test

| | | |
|---|---|---|
| Read delay | 0.00 | sec |

| | | | |
|---|---|---|---|
| Minimum Pressure | 0 bar | Maximum Pressure | Variable bar |
| Tortuosity Factor | 1 | Max air Flow | 200000 cm3 min⁻¹ |
| Wetting Fluid | Galwick | Surface Tension | 15.9 Dynes/cm |

| | |
|---|---|
| Test Type | Capillary Flow Porometry -Wet Up/Dry Up |

The following is the manner of preparation of the sample and the test procedure to be utilized:

(1) Select an untouched and wrinkle-free piece of the material and handle using tweezers. The material to be tested is not to be touched by hand.

(2) Cut a circular shape of the sample with a 1.0 cm diameter.

(3) Fill Petri dish with Galwick 15.9 Dynes/cm wetting fluid. The Petri dish must be clean and dried before using.

(4) Place the sample in a Petri dish such that the fluid completely covers the sample. Leave for 20 seconds then flip the sample using tweezers and re-immerse in the fluid for a further 20 seconds.

(5) Place the saturated sample directly onto the O-ring of the lower sample adaptor, without allowing the wetting fluid to drain, and ensure that the O-ring is completely covered by the sample.

(6) Place the lower sample adapter into the sample chamber using the grippers and predrilled holes, such that the O-ring and sample face upwards.

(7) Close the clamp of upper sample adaptor.

(8) Start the test according to equipment manual.

(9) Record test result in CAPREP program software files.

Following water jet treatment, and preferably before drying of the resultant web material, the web material can be treated with one or more surfactants to further affect, e.g., enhance or modify, web secondary properties such as flame retardancy, anti-static nature, and the like. The surfactants may be topically applied over the entire surface of the web material or within preselected zones. These zones may be provided with the same surfactant or additive or a different surfactant or additive in order to provide zones with different or the same properties. An example of topical treatment suitable for use is described in U.S. Pat. Nos. 5,709,747 and 5,885,656.

Alternatively, a desired surfactant or additive may be added to the polymer melt used to make the meltblown fibers in order to modify one or more secondary properties of the resin fibers.

In the absence of treatment to affect secondary properties, the mean flow pore size provided to the web material based on the parameters for providing the web material, in particular the meltblown fiber layer, results in the web material having acceptable absorbent capacity, absorptive rate and wicking ability. Accordingly, the web material of the invention has absorptive properties without secondary treatment of the fibers either topically or during initial preparation.

The formation of the multi-layer composite, water jet treatment and optional topical treatment may be carried out in a one stage continuous process or may be carried out in different stages to allow for versatility in use scheduling and location of equipment. For example, a composite including the spunbond layer and meltblown layer can be produced and then wound for temporary storage before being subjected to water jet treatment. Further, the layers may be subjected to water jet treatment to provide for a web material of the invention which is usable as such or may be placed in storage and subsequently treated based upon a desired end use for the web material. This versatility provides for cost efficiency in terms of plant space required for the provision of equipment, versatility in the use of different equipment with respect to timing and products and the ability to provide web material with varying properties based on the application to which the material will be put.

Apparatus useful in preparing the web material of the invention is conventional in nature and known to one skilled in the art. Such apparatus includes extruders, conveyor lines, water jets, rewinders or unwinders, topical applicators, calenders or compactors, and the like. The improved properties in the web material of the invention are essentially provided based on the broken meltblown fibers extending through exterior surface(s) of the web material alone or in combination with the mean flow pore size present in the web material which results from the material parameters present with respect to the components which make up the web material of the invention.

While the present invention has been described with respect to exemplary embodiments thereof, it will be understood by those of ordinary skill in the art that variations and modifications can be effected within the scope and spirit of the invention.

It is claimed:

1. A nonwoven web material comprising a composite of at least two layers comprising (a) at least one layer of spunbond continuous fibers and (b) at least one layer of meltblown fibers, wherein said composite is subjected to thermal calender bonding and at least one water jet under conditions sufficient to break at least a portion of said meltblown fibers, wherein ends of said at least a portion of said meltblown fibers extend through and out of at least one exterior surface of said at least one layer of spunbond fibers wherein said spunbond fibers have a denier of about 1 to about 3 dpf, wherein said meltblown fibers have a diameter in a range of about 3 to about 8 microns, and wherein bonds provided by said thermal calender bonding are not destroyed by said at least one water jet.

2. The nonwoven web material according to claim 1, wherein at least a portion of said ends of said meltblown fibers are interspersed within said spunbond layer.

3. The nonwoven web material according to claim 1, wherein said nonwoven web material has a mean flow pore size of about 10 to about 100 microns.

4. The nonwoven web material according to claim 1, wherein the nonwoven web material has a basis weight in a range of about 8-about 60 gsm.

5. The nonwoven web material according to claim 1, wherein said at least one layer of meltblown fibers comprises at least 2% of total weight of the nonwoven web material.

6. The nonwoven web material according to claim 1, wherein said at least one layer of spunbond continuous fibers has a basis weight of at least 3 gsm.

7. The nonwoven web material according to claim 1, wherein said meltblown fibers and said spunbond fibers are polyolefin fibers.

8. The nonwoven web material according to claim 1, wherein said meltblown fibers have a mean fiber diameter of less than 10 microns in the nonwoven web material.

9. The nonwoven web material according to claim 1, wherein said composite comprises at least two spunbond layers as outside layers and one layer of meltblown fibers in between said two layers of spunbond fibers.

10. The nonwoven web material according to claim 1, wherein said composite comprises at least three layers of spunbond fibers present as a combination of outside layers and at least two layers of meltblown fibers positioned in between said at least three layers of spunbond fibers.

11. The nonwoven web material according to claim 1, wherein said at least one water jet sprays water under pressure in a range of about 50-about 400 bar per head.

12. The nonwoven web material according to claim 1, wherein the meltblown fibers comprise a resin having a melt temperature in a range of about 240° C.-about 320° C., a melt flow index of about 400-about 3000, and are produced at extrusion throughputs in a range of about 0.05-1.0 grams per hole per minute and a stretching air speed in a range of about 30-about 150 meters per second.

13. The nonwoven web material according to claim 1, further comprising at least one exterior areal portion topically treated with at least one surfactant.

14. The nonwoven web material according to claim 13, wherein said at least one surfactant provides said web material with a property or enhances a property, wherein said property is fluid phobicity, fluid philicity, flame retardancy and/or an anti-static nature.
